(19) United States
(12) Patent Application Publication
(10) Pub. No.: US 2026/0243216 A1
(43) Pub. Date: Aug. 20, 2026

(54) THRUST REVERSER RING FOR AN AIRCRAFT NACELLE THRUST REVERSER AND AIRCRAFT NACELLE

(71) Applicant: SAFRAN NACELLES, Gonfreville-l’Orcher (FR)

(72) Inventors: Bertrand Léon Marie DESJOYEAUX, Moissy-Cramayel (FR); Laurent Georges VALLEROY, Moissy-Cramayel (FR); Mathieu François Eric PREAU, Moissy-Cramayel (FR)

(73) Assignee: SAFRAN NACELLES, Gonfreville-l’Orcher (FR)

(21) Appl. No.: 19/159,842

(22) PCT Filed: Feb. 28, 2024
(86) PCT No.: PCT/FR2024/050255

§ 371 Date: Aug. 26, 2025

(30) Foreign Application Priority Data
Feb. 28, 2023 (FR) FR2301839

(51) Int. Cl. F02K 1/56; B64D 29/00

(52) U.S. Cl. CPC F02K 1/56; B64D 29/00

(57) ABSTRACT

A thrust reverser ring of an aircraft jet engine extends along a longitudinal axis. The ring includes thrust reverser modules each extending along a longitudinal direction parallel to the longitudinal axis, the thrust reverser modules being distributed circumferentially around the axis so as to form a ring. A thrust reverser module is disposed between two adjacent thrust reverser modules and is mechanically independent of them, the thrust reverser module including a spar which extends along the longitudinal direction and includes two opposite ends spaced from each other along this direction, each end being configured to fix the spar to an aircraft nacelle, and a plurality of transverse blading elements which are distributed along the spar while extending from the spar.

### TECHNICAL FIELD

The present disclosure relates to a thrust reverser ring for an aircraft nacelle thrust reverser and an aircraft nacelle comprising such a thrust reverser ring.

### PRIOR ART

It is known to equip the aircraft nacelles with thrust reverser cascades in order to be able to generate counter-thrust when the aircraft's operating conditions require it. Conventionally, the thrust reverser cascades form a ring surrounding the nacelle and each cascade comprises bladings whose orientation deflects the propulsive air flow towards the front of the jet engine when the cascades are deployed. These cascades are generally fixed to the structure of the nacelle by a front end and an opposite rear end of each cascade. These cascades generally have a rectangular shape with a duckboard architecture that comprises a plurality of parallel spars, each extending axially along a longitudinal direction, and a plurality of bladings that extend transversely between the spars.

Known thrust reverser cascades are manufactured using relatively complex and/or expensive methods.

In view of the above, it would therefore be interesting to be able to manufacture a thrust reverser ring structure for an aircraft nacelle thrust reverser in a simpler manner than in the prior art.

### DISCLOSURE OF THE INVENTION

The object of the invention is thus a thrust reverser ring for an aircraft nacelle thrust reverser, the ring extending around a longitudinal axis, characterized in that the thrust reverser ring comprises a plurality of thrust reverser modules which each extend along a longitudinal direction parallel to the longitudinal axis of the ring and which are distributed circumferentially around the longitudinal axis, at least one thrust reverser module of the plurality of thrust reverser modules being disposed between two adjacent thrust reverser modules and mechanically independent of them, said at least one thrust reverser module comprising:
a single spar which extends along the longitudinal direction and which includes two opposite ends spaced from each other along this direction, each of the two opposite ends being configured to fix the spar to an aircraft nacelle,
a plurality of transverse blading elements which are distributed along the spar while extending from the spar.

At least one of the thrust reverser modules comprising a single spar is mechanically independent of the two adjacent modules which frame it, that is to say it is not mechanically linked or secured to them along a circumferential direction relative to the longitudinal axis of the ring, when considering the modules disposed side by side following the general shape of the ring. The module(s) concerned are simply disposed next to each other and are only mechanically linked to the aircraft nacelle via their two opposite front and rear ends. Such a thrust reverser module structure simplifies the production of the thrust reverser ring structure of an aircraft nacelle and therefore its manufacturing cost, insofar as the module(s) concerned do not need to be assembled with adjacent modules to form cascades which then must each be fixed to the nacelle. Indeed, this/these module(s) are directly positioned and fixed to the nacelle. A thrust reverser module as defined above therefore does not include several spars and a fortiori does not constitute a cascade formed by an intertwining of spars and bladings connected to each other. It should be noted that each end of the spar is only configured to fix the spar to the nacelle, that is to say the thrust reverser module defined above, and not several spars.

According to other possible characteristics, taken alone or in combination:
at least one of the two opposite ends of the spar of said at least one thrust reverser module extends in the continuation of the spar along its longitudinal direction;
at least one of the two opposite ends of the spar of said at least one thrust reverser module includes a plate which extends circumferentially relative to the longitudinal axis of the ring;
at least one of the two opposite ends of the spar of said at least one thrust reverser module includes a plate which extends transversely relative to the longitudinal direction of the spar;
the spar including two large opposite faces, said at least one thrust reverser module includes at least one lateral closing board of the module which extends parallel to a first of the two large opposite faces of the spar and opposite the transverse blading elements which extend from said first large face of the spar;
said at least one thrust reverser module includes two lateral closing boards of the module which extend respectively parallel to the two large opposite faces of the spar and which are respectively disposed opposite the transverse blading elements which extend from each of the two large opposite faces of the spar;
the lateral closing board(s) of the module are also fixed to the large face of the spar which is opposite the concerned board;
the spar including two large opposite faces, the transverse blading elements extend from each of the two large opposite faces of the spar;
the transverse blading elements are distributed on the two large opposite faces of the spar in a symmetrical manner with respect to the spar, a blading element on one of the two large opposite faces of the spar being disposed longitudinally facing a blading element on the other large opposite face of the spar;
the transverse blading elements extend on either side of the spar while being offset longitudinally from one of the two large opposite faces of the spar to the other large opposite face of the spar;
the transverse blading elements extend from only one of the two large opposite faces of the spar.

The object of the invention is also an aircraft nacelle comprising a thrust reverser ring as briefly set out above.

The object of the invention is further a method for producing a thrust reverser ring for an aircraft nacelle thrust reverser, the ring extending along a longitudinal axis. The method comprises the following steps:
providing a plurality of thrust reverser modules each comprising, on the one hand a single spar which extends along a longitudinal direction and which includes two opposite ends spaced from each other along this direction and, on the other hand a plurality of transverse blading elements which are distributed along the spar while extending from the spar,
positioning the thrust reverser modules on an aircraft jet engine nacelle by distributing them circumferentially around the longitudinal axis of the ring so as to form a thrust reverser ring, the longitudinal directions of the thrust reverser modules being parallel to the longitudinal axis of the ring,
fixing at least one thrust reverser module of the plurality of thrust reverser modules on the nacelle solely by means of the two opposite ends of the spar of said at least one module so that said at least one thrust reverser module is disposed between two adjacent thrust reverser modules while being mechanically independent of them.

The method briefly set out above thus allows simply producing a new thrust reverser ring configuration for a thrust reverser of an aircraft nacelle. Said at least one thrust reverser module set out above (with its single spar) is indeed directly positioned on the nacelle and fixed to it, without needing to be fixed to the adjacent modules disposed circumferentially on either side of it. The method may also include any one of the characteristics defined above in relation to the thrust reverser ring.

### BRIEF DESCRIPTION OF THE DRAWINGS

Other characteristics and advantages of the object of the present disclosure will emerge from the following description of embodiments, given as non-limiting examples, with reference to the appended figures.

FIG. 1 is a schematic general view of a thrust reverser module of a thrust reverser ring according to one embodiment of the invention;

FIG. 2 is a schematic general view of an aircraft nacelle comprising a thrust reverser ring formed by one or more of the modules such as the one illustrated in FIG. 1 and which is/are only fixed to the nacelle;

FIG. 3A is a partial schematic general view of a free end of a thrust reverser module spar according to a first embodiment of the invention;

FIG. 3B is a partial schematic general top view showing two adjacent thrust reverser modules fixed by each of their free ends identical to that of FIG. 3A;

FIG. 4A is a partial schematic general view of a free end of a thrust reverser module spar according to a second embodiment of the invention;

FIG. 4B is a partial schematic general view showing the fixing of the two opposite free ends of the module of FIG. 4A;

FIG. 5A is a partial schematic general view of a free end of a thrust reverser module spar according to a third embodiment of the invention;

FIG. 5B is a partial schematic general view showing the fixing of the two opposite free ends of the module of FIG. 5A;

FIG. 6A is a general view of a thrust reverser module of a thrust reverser ring according to another embodiment of the invention;

FIG. 6B is a partial schematic top view showing the assembly of blading elements with one of the closing boards of the module of FIG. 6A;

FIG. 7A is a partial schematic top view showing a thrust reverser module according to a first variant of embodiment;

FIG. 7B is a partial schematic top view showing a thrust reverser module according to a second variant of embodiment.

### DETAILED DESCRIPTION

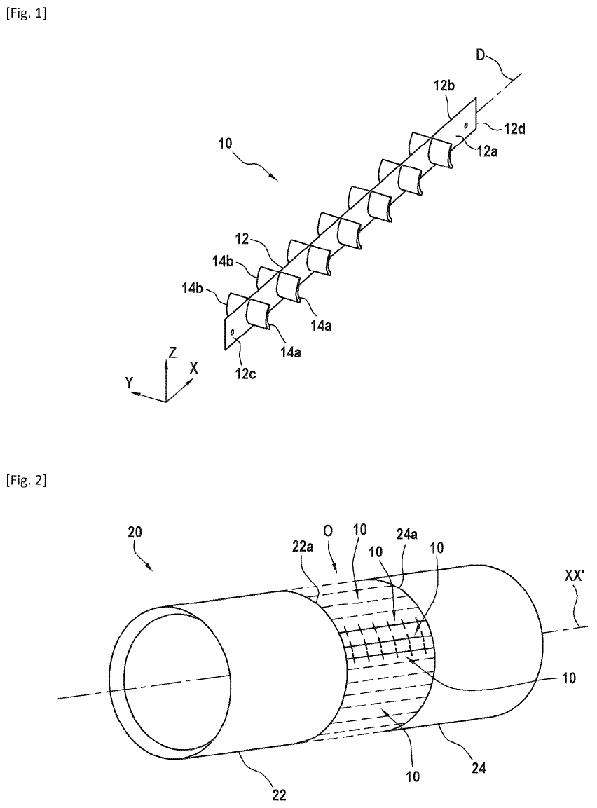

As schematically represented in FIG. 1 and designated by the general reference 10, a thrust reverser module according to one embodiment of the invention generally comprises a single spar 12, and a plurality of blading elements 14a-b disposed transversely relative to a longitudinal direction D of the spar being distributed along the latter and fixed thereto.

The spar 12 more particularly comprises two large opposite faces 12a, 12b (the large face 12a being visible in perspective in FIG. 1) which, in a three-dimensional reference frame X, Y, Z, each extend mainly in a plane defined by the two directions X (longitudinal direction) and Z (height or radial direction). The spar also has a thickness (not represented in the very schematic FIG. 1) which extends along the third direction Y, perpendicularly to the planes of the two large opposite faces 12a, 12b when these are planar.

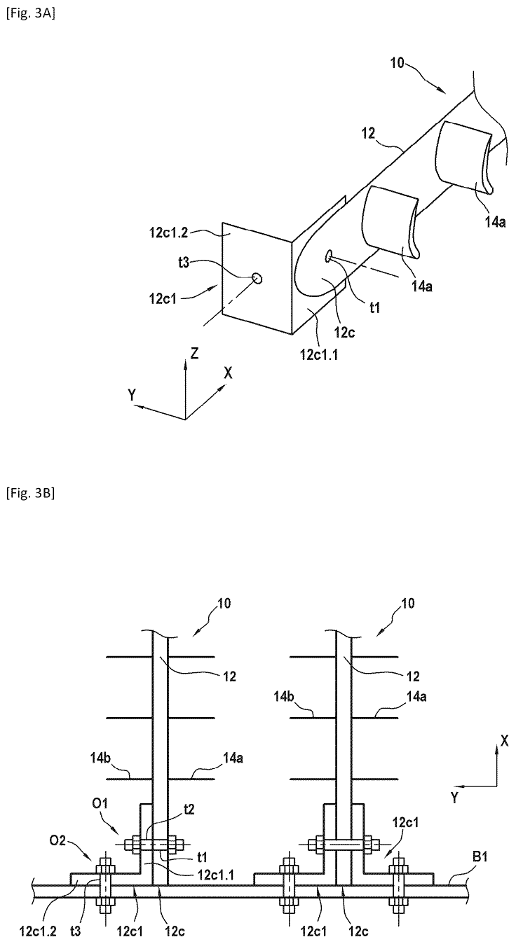

The spar 12 includes two opposite ends 12c, 12d spaced from each other along the longitudinal direction D (axis X) and which are each configured to fix the spar 12 to an aircraft nacelle such as the one schematically illustrated in FIG. 2. Different possible configurations of spar ends will be described later with reference to FIGS. 3A to 5B.

In the embodiment represented in FIG. 1, the transverse blading elements 14a-b are connected to each of the two large opposite faces 12a, 12b of the spar. The thrust reverser module 10 thus includes a first group of transverse blading elements 14a connected to the first large face 12a and a second group of transverse blading elements 14b connected to the second large opposite face 12b.

In this embodiment, the two groups of transverse blading elements are connected symmetrically with respect to the spar 12, thus giving the module a general ladder shape in top view. More particularly, a blading element 14a disposed on the large face 12a of the spar is disposed along the longitudinal direction D of the spar facing a blading element 14b disposed on the other large opposite face 12b of the spar.

The two opposite ends 12c and 12d of the spar for example have the configuration illustrated in FIG. 3A for the end 12c: each end extends longitudinally in the continuation of the spar, that is to say it extends along a plane defined by the directions X and Z, like the two large opposite faces 12a and 12b of the spar. Each end includes one or more fixing holes (in FIG. 3A a single fixing hole t1 passing through the thickness, along the direction Y, of the end 12c is represented). A fixing plate 12c1 is attached onto the end 12c in order to fix the latter (and therefore the spar) to a part of the aircraft nacelle forming a support for the spar. In the embodiment represented, the plate 12c1 extends in the continuation of the end 12c by a portion 12c1.1, then extends transversely relative to the longitudinal direction D of the spar 12, in the form of a bent-back portion 12c1.2. FIG. 3B illustrates in top view (in projection in a plane XY) two modules 10 adjacent to each other which are not mechanically linked together (mechanical independence along a transverse or circumferential direction) but which are each mechanically linked to a peripheral edge B1 of the nacelle by means of their free end 12c. As represented, the generally L-shaped fixing plate 12c1 is fixed to the end 12c with one or more appropriate fixing member(s) (e.g. bolts, rivets, etc.) O1 cooperating with the fixing hole t1 and the corresponding fixing hole t2 of its portion 12c1.1. The fixing plate 12c1 is fixed to the edge B1 with one or more appropriate fixing member(s) (e.g. bolts, rivets, etc.) O2 cooperating with the fixing hole t2 of its portion 12c1.2. As represented for the module 10 on the right of FIG. 3B, a second plate 12c1 (this plate may or may not be identical to the plate used for the module 10 on the left) may be provided on the opposite face of the free end 12c to reinforce the fixing of the spar on the edge B1. The two fixing plates thus frame the free end 12c of the spar on either side. The same mounting can be provided at the opposite end (not represented) of the spars. In FIG. 3B two modules 10 have been represented side by side (disposed circumferentially around a longitudinal axis XX′ of the ring and of the nacelle illustrated in FIG. 2) but, in one variant of embodiment not represented, the module 10 of FIGS. 1 and 3A can be disposed next to a different thrust reverser module, for example of the conventional type (spar carrying transverse blading elements). Generally, the shape of each plate adapts to the shape of revolution of the part of the nacelle on which each plate is fixed and can thus for example adopt a curvature around the axis Y.

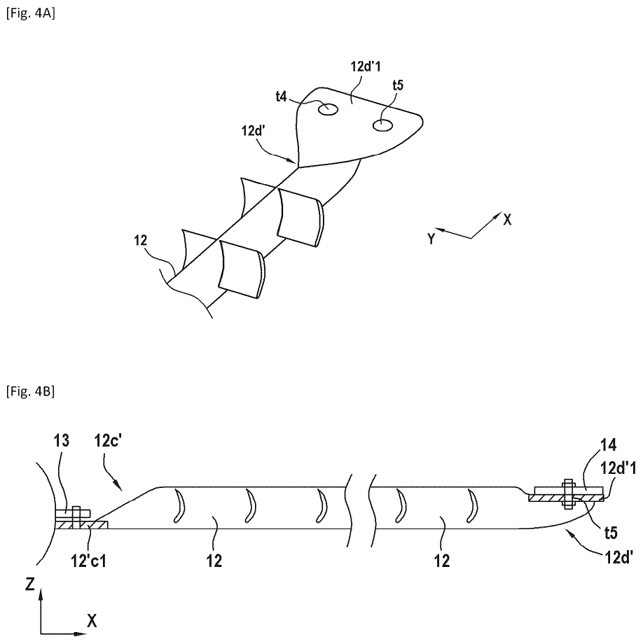

FIGS. 4A and 4B illustrate another embodiment in which each of the two opposite ends 12c′, 12d′ of the single spar 12 includes a plate 12c′1, 12′d1 which extends, on the one hand in the continuation of the longitudinal direction of the spar 12 and, on the other hand by flaring laterally or transversely with respect to this longitudinal direction. It will be noted that, depending on the concerned end of the spar, the plate is arranged against the rim or longitudinal edge of the spar corresponding to the leading edge or to the trailing edge of the blading elements, as illustrated in FIG. 4B. The plate is for example a piece mechanically attached onto the end of the spar or forming an integral part of the spar which is generally manufactured by injection molding. The plate 12c′1, 12′d1 thus extends substantially in a plane XY which is perpendicular to the plane XZ of the two large opposite faces of the spar. The plate may not extend specifically in the plane XY insofar as its general shape may be slightly curved with a convexity which is directed upwards along Z (FIG. 4B) so as to match a complementary shape (concavity turned downwards) of a part of the nacelle on which the end 12c′, 12d′ is intended to be fixed. Generally, the shape of each plate adapts to the shape of revolution of the part of the nacelle on which each plate is fixed and may thus for example adopt a curvature around the axis X. The plate has a general flattened and flared shape giving the plate, when viewed from above, a substantially trapezoidal or spatula shape. Fixing holes t4 and t5 passing through the thickness of the plate 12d′1 (resp. 12c′1) cooperate with appropriate fixing members (e.g. bolts, rivets, etc.) in order to fix the end 12d′ (resp. 12c′) (and therefore the spar) to the part of the aircraft nacelle forming a support for the end of the spar. In FIG. 4B, parts 13, 14 respectively forming supports for the two opposite ends 12c′ and 12d′ of the spar have been represented (these parts 13, 14 are secured to the nacelle) and thus allow fixing each plate 12c′1, 12d′1 on the concerned part 13, 14 (and therefore on the concerned peripheral edge of the nacelle) by means of appropriate fixing members cooperating with the holes t4 and t5. When the plates 12c1, 12d′1 are positioned on the nacelle (FIG. 2), each plate extends circumferentially relative to the longitudinal axis XX′ of the ring and of the nacelle.

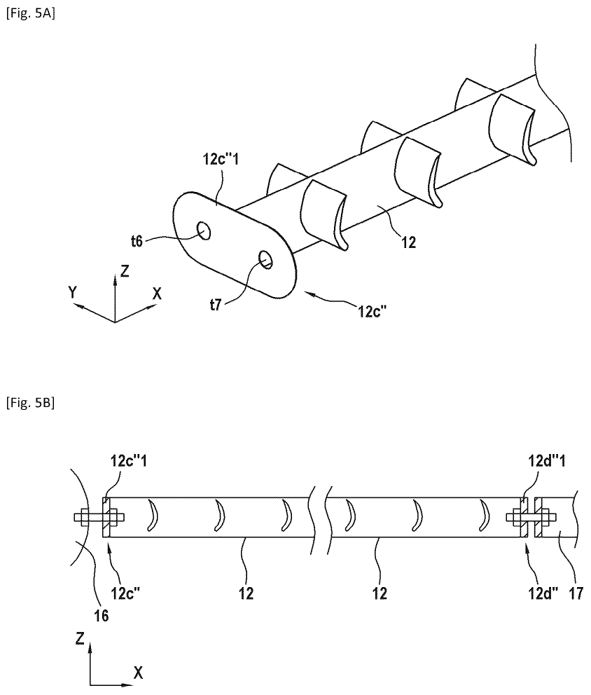

FIGS. 5A and 5B illustrate another embodiment in which each of the two opposite ends 12c″, 12d″ of the single spar 12 includes a plate 12c″1, 12″d1 which extends transversely relative to the longitudinal direction of the spar 12 and here in a transverse plane defined by the directions Y and Z. Generally, the shape of the plates 12c″1, 12″d1 adapts to the shape of revolution of the part of the nacelle on which each plate is fixed and can thus, for example, adopt a curvature around the axis Y in addition to its general T-shape seen from above (in projection in a plane XY). Fixing holes t6 and t7 passing through the thickness of the plate 12c″1 in FIG. 5A cooperate with appropriate fixing members (e.g. bolts, rivets, etc.) in order to fix the end 12c″ (and therefore the spar) to the part of the nacelle forming a support for the end of the spar. In FIG. 5B, parts 16, 17 respectively forming supports for the two opposite ends 12c″ and 12d″ of the spar have been represented and thus allow fixing each plate 12c″1, 12d″1 on the concerned part 16, 17 by means of appropriate fixing members cooperating with the holes t6 and t7. When the plates 12c″1, 12d″1 are positioned on the nacelle (FIG. 2), each plate extends circumferentially relative to the longitudinal axis XX′ of the jet engine and of the nacelle.

FIG. 2 illustrates an aircraft nacelle 20 of known type, comprising, aligned along the longitudinal axis XX′, a front cowling 22 and a rear cowling 24 delimiting therebetween an annular opening O intended to accommodate a thrust reverser ring for an aircraft nacelle thrust reverser. The thrust reverser comprises in particular, in addition to the thrust reverser ring, actuators which, when controlled by one or more actuating unit(s) (engine(s)), allow activating the functional elements of the ring and therefore deflecting the air flow passing through the ring. The aircraft nacelle forms, with the engine or turbomachine, a propulsion assembly of the aircraft.

To produce a thrust reverser ring according to one embodiment of the invention, a plurality of thrust reverser modules are provided and include one or more module(s) 10 in accordance with what has been previously described. The other thrust reverser modules used to form the ring comprise spars to which transverse blading elements are connected and which can be mechanically linked together as in the prior art, unlike the modules 10 previously described.

In a minimal thrust reverser ring configuration, the ring comprises a single thrust reverser module 10 and the other modules are for example of the conventional type and assembled together so as to form cascades which are then mounted on the nacelle.

In a different thrust reverser ring configuration, the latter only comprises thrust reverser modules 10 in accordance with what has been previously described in order to simplify the production of the ring as much as possible. In another configuration, the thrust reverser ring comprises, on the one hand several thrust reverser modules 10 in accordance with what has been previously described, not necessarily adjacent to each other and, on the other hand conventional thrust reverser modules or conventional cascades. Whatever the configuration chosen, the thrust reverser module(s) 10 are mechanically independent of the adjacent modules (namely the two adjacent modules which frame a thrust reverser module 10).

Each thrust reverser module 10 is positioned in the annular opening O defined previously, at a radial position, taken relative to the longitudinal axis XX′ of the nacelle, which corresponds substantially to that of two respective front and rear peripheral edges 22a and 24a of the two front and rear cowlings. The two front and rear peripheral edges 22a and 24a are longitudinally separated from each other by the annular opening O. Each of the two peripheral edges forms a fixing support for one of the two opposite ends of the spar of each of the thrust reverser modules. In this regard, each edge may be configured in a suitable manner to allow such fixing, in particular one of the fixing methods described above in relation to FIGS. 3A-5B and may for example include a fixing piece dedicated to this purpose (e.g.: annular flange extending over the circumference of the concerned peripheral edge or annular segments).

In practice, the or each thrust reverser module 10 is positioned by fixing the two opposite ends of the module to the two respective edges 22a and 24a of the nacelle. In one example of a thrust reverser ring configuration represented in FIG. 2, several modules 10 are present and adjacent with respect to each other. A module 10 is positioned next to an adjacent module 10, previously fixed to the nacelle, without being connected or mechanically linked (voluntarily) to this adjacent module in any way (in particular without being linked laterally or circumferentially to this adjacent module). The same is true with the module disposed on the opposite side. The adjacent modules 10 two by two are freely disposed next to each other, a slight lateral/circumferential mechanical clearance even being provided between these modules. More particularly, when two modules 10 are positioned side by side in the annular opening O, a group of transverse blading elements of one of the two modules is disposed facing another group of transverse blading elements of the adjacent module and, more particularly, the transverse blading elements facing the two modules 10 are disposed in the same position relative to the longitudinal direction of the spars of these modules. Although these facing transverse blading elements are not connected to each other and there is even a mechanical clearance between them, the overall impression that emerges from the geometric juxtaposition of these modules is that the transverse blading elements facing each other are each considered as a half-blading and that two facing half-bladings thus generally form a single transverse blading. The foregoing also applies to the case where a module 10 is disposed next to a conventional module which may for its part be mechanically linked to another conventional module.

The thrust reverser modules 10 of FIG. 2 are thus positioned next to each other in the annular opening O and are distributed circumferentially around the axis XX′, so as to form a thrust reverser ring structure where only three modules 10 have been detailed (the other modules 10 have been symbolically represented by dotted lines parallel to each other). It will be noted that the modules 10 present in the structure of the thrust reverser ring may not be adjacent to each other but be dispersed within the plurality of the other thrust reverser modules. For example, each module 10 may be disposed between two thrust reverser cascades which are each formed of several conventional thrust reverser modules (a conventional cascade is formed from an intertwining of spars and transverse blading elements generally obtained in a single block by injection molding).

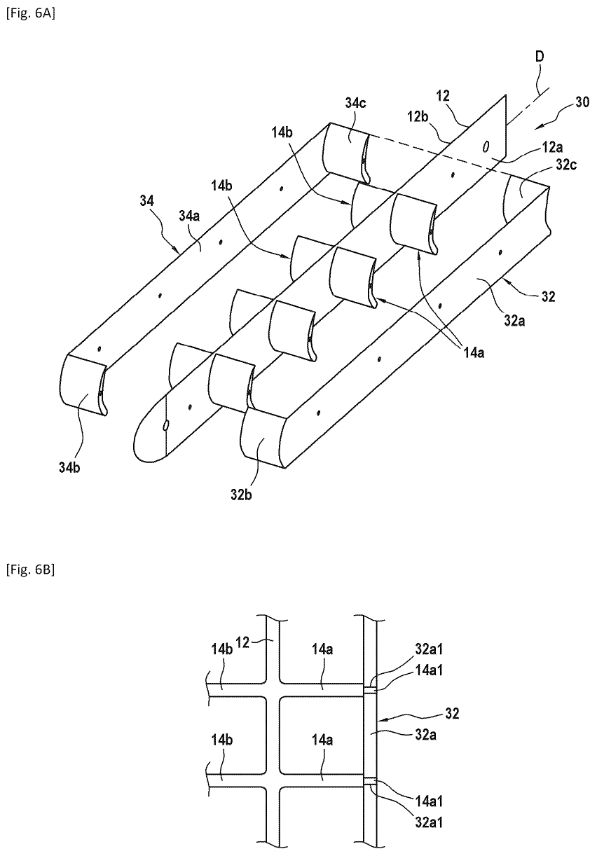

In FIG. 6A, a thrust reverser module 30 according to another embodiment of the invention is represented. The references assigned to the elements of the module 10 of FIG. 1 have been repeated insofar as the elements concerned are not modified.

The thrust reverser module 30 includes at least one board, here two lateral closing boards 32, 34 of the module which extend respectively parallel to the two large opposite faces 12a, 12b of the single spar, namely in a plane XZ. The two closing boards 32, 34 are respectively disposed opposite the two large opposite faces 12a, 12b of the spar. Each plate 32, 34 is for example fixed to the transverse blading elements 14a, 14b connected to the spar 12 and which extend from the large face of the spar which is opposite the board concerned. The two closing boards 32, 34 thus form lateral end flanks for the blading elements. In the embodiment represented, each board 32 and 34 may also include two bent-back portions 32a, 32b and 34a, 34b which extend transversely in the direction of the spar 12, respectively from the two opposite ends of the central part 32a, 34a of the concerned board. As represented in FIG. 6A, each of the bent-back portions is fixed to the large face facing the spar. Thus, each board provided with its two bent-back portions forms a laterally closed structure for the module of FIG. 1 which is composed of the spar and of the transverse blading elements. When several modules 30 are placed on the nacelle to adopt the ring configuration of FIG. 2 (it will be noted that only one module 30 can be present in a thrust reverser ring), two adjacent modules 30 are thus closed with respect to each other along the circumferential direction given by the thrust reverser ring and without mechanical link with each other. The same is true between a module 30 and an adjacent module or an adjacent conventional cascade. In this way, the cavities which define the passages for the reverser air flow through the thrust reverser ring are now each delimited inside the same module: each cavity traversed by the air flow is delimited by the spar of the module, two consecutive blading elements (along the longitudinal direction of the spar) located on the same large face and the facing closing board. In the installed configuration of FIG. 2 with the modules 10 of FIG. 1, each cavity traversed by the air flow is delimited by the two spars facing two adjacent modules 10 and by the two consecutive half-bladings located on the same large face of one of the two modules 10 and by the two facing consecutive half-bladings located on the same large face of the other module 10. For the same transverse half-blading dimension, the configuration of FIG. 2 with the modules 30 has air passage cavities of smaller section than with the modules 10. However, it can be envisaged that the blading elements of the modules 30 have a transverse dimension corresponding substantially to the sum of the transverse dimensions of the two blading elements facing the two adjacent modules 10. As with the modules 10 of FIG. 1, in the installed configuration of FIG. 2 with the modules 30 of FIG. 6A, the modules 30 which are disposed adjacent with respect to each other along the circumferential direction of the thrust reverser ring are mechanically independent of each other along this direction, that is to say they are not mechanically linked to each other (in particular by their closing boards 32, 34) and are even slightly transversely/circumferentially spaced apart from each other by a small circumferential clearance.

The lateral closing boards may be fixed to the blading elements of the single spar by various means. For example, a mounting of the mortise-and-tenon type may be used in which the distal ends of the blading elements each carry one or more protrusions (e.g., protrusions 14a1 for the blading elements 14a) which are housed in openings facing the corresponding closing board (e.g., openings 32a1 of the closing board 32), as represented in FIG. 6B. It will be noted that the securing between blading element and board may be achieved by crushing of the head of the protrusion or tenon as for the crushing of the rivet heads. Alternatively, it can for example be envisaged to bond or weld the distal ends of the blading elements to the facing closing board. The fixing of the two lateral closing boards may be identical. It should be noted that the bent-back portions of the two lateral closing boards can also be fixed to the central spar in the same manner as described above.

Generally, the lateral closing boards allow improving the mechanical strength of the blading elements and channeling the air flow over the entire transverse dimension of the blading elements, unlike the embodiments that use only the modules of FIG. 1.

It should be noted that the configuration of the module of FIG. 6A can alternatively be achieved differently. For example, the blading elements 14a and 14b can be carried respectively by the lateral boards 32 and 34 and are connected to the large face facing the spar 12 in the same manner as described above. The spar 12 for its part does not carry any spar (in one variant not represented, the blading elements are distributed between the boards and the spar). Thus, in the final configuration, the blading elements 14a and 14b extend respectively between the boards 32, 34 and the large facing faces of the spar.

In one variant of embodiment not represented, the spar carries blading elements and the module includes one or two lateral closing boards which are for example not fixed to the blading elements of the spar.

In the embodiment described, all the thrust reverser modules that constitute the thrust reverser ring have the configuration of FIG. 6A. However, according to one variant not represented, only one or some of the modules of the ring may have this configuration, the other modules having the configuration of FIG. 1 or a conventional configuration, or the other modules comprise one or more modules with the configuration of FIG. 1 and one or more modules with a conventional configuration. For example, in the areas where it is desired to longitudinally and transversely deflect the air flow, the blading elements must deflect the flow longitudinally and the spars must also deflect the flow transversely. For these cases, the module in FIG. 6A, which gives more transverse stiffness to the flow deflection module, is more suitable. The spars are then also profiled.

It will be noted that, in a thrust reverser ring configuration installed on a jet engine nacelle, the module 30 of FIG. 6A may not be disposed next to another module 30 but, for example, next to a conventional thrust reverser cascade, without being mechanically linked thereto. The use, in a thrust reverser ring, of modules according to the invention, in addition to conventional cascades, allows for example disposing several modules circumferentially instead of having to produce a cascade of smaller width with a mold different from the mold which is used to produce the conventional cascades of the ring. The manufacture of the ring is thus simplified.

Moreover, the use, in a thrust reverser ring (with or without conventional cascades), of modules according to the invention, allows orienting the deflected jet more easily by modifying the reorientation of each module separately, where that proves more difficult within a conventional cascade given the interaction between a given spar and the other spars of the cascade.

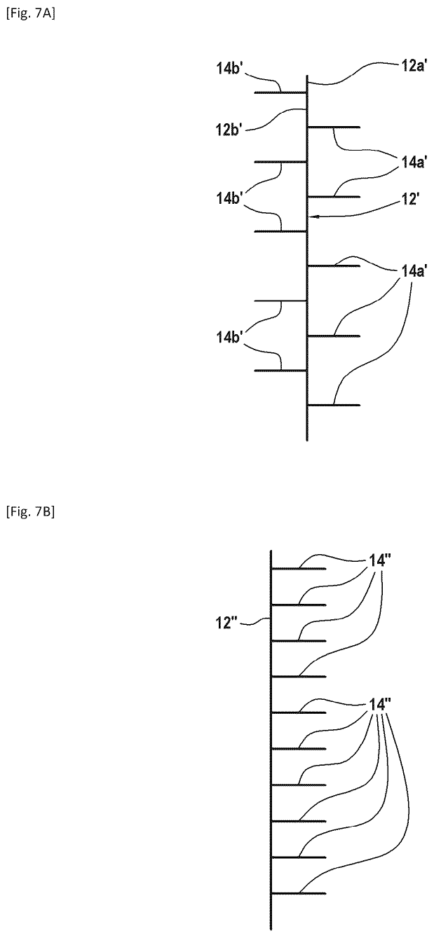

In one variant of embodiment represented in FIG. 7A, the transverse blading elements are offset longitudinally from a large face 12a′ of the spar 12 to the opposite large face 12b′ of the spar. In other words, the first group of transverse blading elements 14a′ connected to the first large face 12a′ of the spar is offset longitudinally with respect to the second group of transverse blading elements 14b′ connected to the second opposite large face 12b′ of the spar (asymmetry). In other words, the transverse blading elements are staggered along the spar 12′ on either side thereof: a transverse blading element of one of the two groups of transverse blading elements which are connected to a large face is disposed, along the spar, between two transverse blading elements of the other group which are connected to the opposite large face. The module of FIG. 7A thus has the general shape of a ladder with offset rungs. It will be noted that lateral closing boards, similar or identical to those of FIG. 6A, may be added to the module of FIG. 7A.

In one variant of embodiment represented in FIG. 7B, the transverse blading elements 14″ are disposed on only one side of the spar 12″ and are therefore connected to only one of the two large opposite faces of the spar, thus giving the module a general comb shape. It will be noted that a lateral closing board, similar or identical to one of the boards in FIG. 6A, may be added to the module in FIG. 7B on the side where the transverse blading elements 14″ extend.

It will be noted that in any one of the modes and variants described above, the ring may be locally interrupted to take specific arrangements into account. It may thus be interrupted to leave a passage for a pylon or mast used to suspend the engine.

Generally, the ring that is the object of the invention does not, strictly speaking, extend over 360°, but it nevertheless has a thrust reverser structure in the general shape of a ring.

Although the present description refers to specific exemplary embodiments, modifications may be made to these examples without departing from the general scope of the invention as defined by the claims. Furthermore, individual characteristics of the various embodiments illustrated or mentioned may be combined in additional embodiments. Consequently, the description and the drawings should be considered in an illustrative rather than restrictive sense.

1. A thrust reverser ring for an aircraft nacelle thrust reverser, the ring extending around a longitudinal axis, wherein the thrust reverser ring comprises a plurality of thrust reverser modules which each extend along a longitudinal direction parallel to the longitudinal axis of the ring and which are distributed circumferentially around the longitudinal axis, at least one thrust reverser module of the plurality of thrust reverser modules being disposed between two adjacent thrust reverser modules and mechanically independent of them, said at least one thrust reverser module comprising:
a single spar which extends along the longitudinal direction and which includes two opposite ends spaced from each other along this direction, each of the two opposite ends being configured to fix the spar to an aircraft nacelle,
a plurality of transverse blading elements which are distributed along the spar extending from the spar.

2. The thrust reverser ring according to claim 1, wherein at least one of the two opposite ends of the spar of said at least one thrust reverser module extends in the continuation of the spar along its longitudinal direction.

3. The thrust reverser ring according to claim 1, wherein at least one of the two opposite ends of the spar of said at least one thrust reverser module includes a plate which extends circumferentially relative to the longitudinal axis of the ring.

4. The thrust reverser ring according to claim 1, wherein at least one of the two opposite ends of the spar of said at least one thrust reverser module includes a plate which extends transversely relative to the longitudinal direction of the spar.

5. The thrust reverser ring according to claim 1, wherein the spar including two large opposite faces, said at least one thrust reverser module includes at least one lateral closing board of the module which extends parallel to a first of the two large opposite faces of the spar and opposite the transverse blading elements which extend from said first large face of the spar.

6. The thrust reverser ring according to claim 1, wherein the spar including two large opposite faces, the transverse blading elements extend from each of the two large opposite faces of the spar.

7. The thrust reverser ring according to claim 6, wherein the transverse blading elements are distributed on the two large opposite faces of the spar in a symmetrical manner with respect to the spar.

8. The thrust reverser ring according to claim 6, wherein the transverse blading elements extend on either side of the spar while being offset longitudinally from one of the two large opposite faces of the spar to the large opposite face of the spar.

9. The thrust reverser ring according to claim 1, wherein the transverse blading elements extend from only one of the two large opposite faces of the spar.

10. An aircraft nacelle, wherein it comprises a thrust reverser ring for a thrust reverser according to claim 1.

11. A method for producing a thrust reverser ring for an aircraft nacelle thrust reverser, the ring extending along a longitudinal axis, the method comprises the following steps:
providing a plurality of thrust reverser modules each comprising, on the one hand a single spar which extends along a longitudinal direction and which includes two opposite ends spaced from each other along this direction and, on the other hand a plurality of transverse blading elements which are distributed along the spar while extending from the spar,
positioning the thrust reverser modules on an aircraft jet engine nacelle by distributing them circumferentially around the longitudinal axis of the ring so as to form a thrust reverser ring, the longitudinal directions of the thrust reverser modules being parallel to the longitudinal axis of the ring,
fixing at least one thrust reverser module of the plurality of thrust reverser modules on the nacelle solely by means of the two opposite ends of the spar of said at least one module so that said at least one thrust reverser module is disposed between two adjacent thrust reverser modules while being mechanically independent of them.
